(19) United States
(12) Patent Application Publication
(10) Pub. No.: US 2014/0050081 A1
(43) Pub. Date: Feb. 20, 2014

(54) Reduced bandwidth transmission for multiple sensors utilized to monitor a system

(71) Applicant: Ronald E. Wagner, Fleming Island, FL (US)

(72) Inventor: Ronald E. Wagner, Fleming Island, FL (US)

(73) Assignee: BAE Systems Information and Electronic Systems Integration, Inc.

(21) Appl. No.: 12/807,916

(22) Filed: Sep. 16, 2010

Related U.S. Application Data
(60) Provisional application No. 61/342,107, filed on Apr. 9, 2010.

(51) Int. Cl. H04L 12/26

(52) U.S. Cl. 370/230

(57) ABSTRACT

In a system for monitoring multiple sensors, a technique is utilized to reduce the bandwidth necessary to transmit sensor data to a processing location by embedding a diagnostic and/or prognostic algorithm at the sensor location and providing that the algorithm outputs only values that are greater than predetermined exceedances for each of the sensors involved, and by monitoring only performance parameters that are critical to the monitored system.

### RELATED APPLICATIONS

This Application claims rights under 35 USC §119(e) from U.S. application Ser. No. 61/342,107 filed Apr. 9, 2010, the contents of which are incorporated herein by reference.

### FIELD OF THE INVENTION

This invention relates to monitoring systems and more particularly to the reduction of the bandwidth necessary to transmit sensor data to a processing location.

### BACKGROUND OF THE INVENTION

In fleet management and in other monitoring situations in which a number of sensors are employed to sense various parameters of operation, the number of sensors may be exceedingly large. Thus, in a heavy sensor deployed environment one has difficulties in the management of the bandwidth necessary to transmit the monitored data and the preventing of the collision of data that is obtained and which is to be analyzed for system performance. In some cases there may be as many as 200 or 300 sensors for a given application and it is important that no critical data be lost in the transmission.

If the sensors are continuously providing data there is a bandwidth issue, or if sampling is used sampled data may not provide enough information or information that is not good enough for monitoring critical parameters. Critical parameters can for instance include such things as temperature change. If one is sampling temperature once a minute this may be insufficient. For instance, in a minute the temperature might change five times. This is particularly troublesome if one is measuring temperature for preserving perishable commodities that are exposed for instance to rapid and unpredictable temperature changes. If rapid temperature changes exist, outputting temperature every minute or every five minutes might not alert personnel to food spoilage.

Moreover if there is a dense environment in which multiple individuals are wearing devices having sensors, if these are continuously transmitting sensors, then unless an appropriate communication system is established, the monitoring system may miss transmissions from an individual who is not online at a given point in time. This lack of information may be critical to that person.

Thus data bandwidth may be excessive when multiple sensors are communicating to a processing point simultaneously; and in the past the sampling systems that have been used may result in missed data.

### SUMMARY OF INVENTION

In order to eliminate communications bottlenecks, in one embodiment a diagnostic and/or prognostication algorithm is embedded at the point of performance in which there are multiple sensors. The algorithm measures and outputs only values that exceed the exceedance parameters defined for each of the sensors involved. Note, not only are the exceedance parameters defined, sensed and transmitted, in one embodiment the algorithm utilized for detecting faults is embedded in a microprocessor at the point of performance. Thus for the specific algorithm involved at the point of performance, the only performance parameters that are monitored are those that are critical and then only those that have exceedances which are deemed to be of importance.

In one embodiment, the data derived from the subject system is sent back to a central processing location utilizing a burst transmission mode operating with time domain multiple access techniques in order to avoid collisions with other data transmissions.

Thus, the algorithm that interfaces the sensors to central processing filters the sensor outputs for exceedances, decides which sensors are more important than others, and then transmits only those sensor exceedances in predefined time slots so as to minimize the amount of data which is transmitted to central processing.

The result for fleet management, healthcare and for other enterprises is the ability to sample a large variety of parameters but limit the amount of information to only exceedances of various parameter levels for critical sensors, and to assign TDMA time slots only to the sensor exceedances that are deemed to be critical.

Thus, in a system for monitoring multiple sensors, a technique is utilized to reduce the bandwidth necessary to transmit sensor data to a processing location by embedding a diagnostic and/or prognostic algorithm at the sensor location and providing that the algorithm outputs only values that are greater than predetermined exceedances for each of the sensors involved, and by monitoring only performance parameters that are critical to the monitored system.

In summary, an algorithm is defined that defines the exceedances that are important. Secondly, the algorithm is embedded at the point of performance and thirdly, a time domain multiple access technique is utilized to transmit exceedance information from critical sensors in predefined time slots.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of the embedding of an algorithm at the point of performance and to utilize a communications device involving TDMA to provide a burst of data to a remote processing location; and,

FIG. 2 is a diagrammatic illustration of multiple sensors coupled to a controller that is embedded at the point of performance which functions as a filter to filter particular sensors deemed to be of critical interest, to define exceedances of the outputs of these sensors and transmits this exceedance information during assigned time slots.

### DETAILED DESCRIPTION

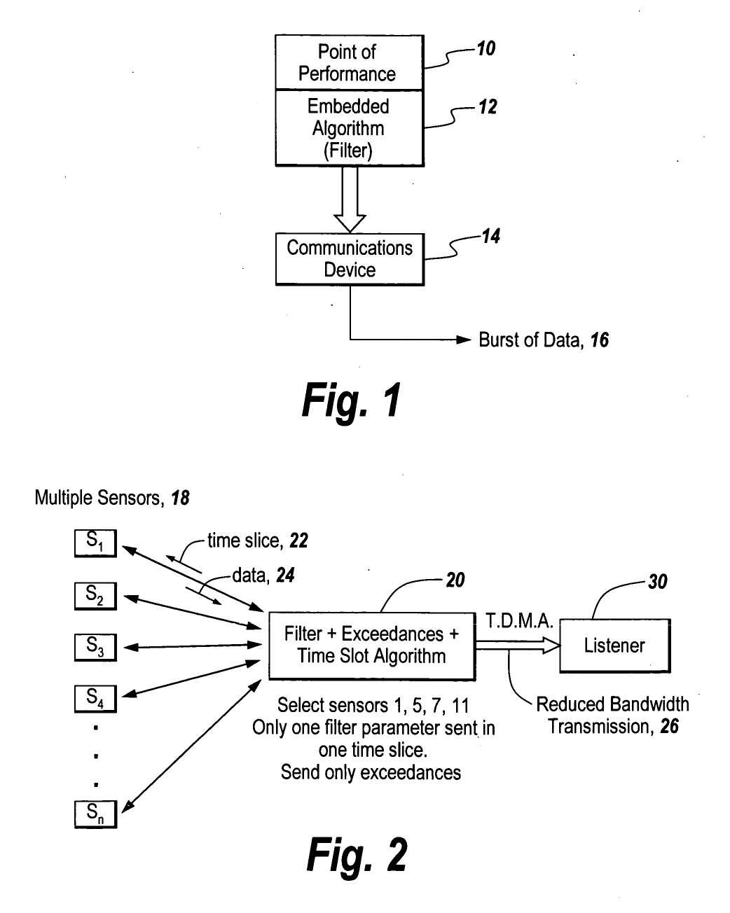

Referring now to FIG. 1, whether the system is involved in fleet management, medical information sensing or the transmission of sensor data from smart tags worn on military personnel, or whether the multiple sensors are utilized for any type of enterprise system, in one embodiment an algorithm 12 is embedded at the point of performance 10 in a microprocessor to filter which sensors are thought to be important. The system then defines exceedances of the sensor outputs which are deemed critical and provides a time division multiple access output to a communications device 14 that transmits a reduced data set of information in a burst of data 16.

More particularly and referring to FIG. 2, multiple sensors 18 here labeled S₁, S₂, S₃, S₄, . . . , Sₙ have their outputs coupled to a controller 20 that includes a microprocessor that has a processing algorithm. The filter filters which sensors are said to have critical data and defines exceedances of these sensors such that that which is transmitted from the controller is not the raw sensor data, but only the fact of exceedances and data relating to the magnitude of the exceedances. The exceedances are again filtered in terms of time slot allotment utilizing a time slot algorithm such as a time division multiple access algorithm, such that for instance if sensor S₁ is allotted a time slice 22, then the data 24 from the sensor is coupled to controller 20, whereupon it is analyzed for exceedances as defined by the embedded algorithm.

Assuming that the S₁ output exceeds certain threshold levels, the fact of the exceedance is transmitted in a reduced bandwidth transmission 26 to a listener 30, in one embodiment using a time division multiple access system. It will be appreciated that while time division multiple access is disclosed herein, code division multiple access or other types of multiplexing schemes are within the scope of this invention. Note not only the fact of an exceedance is transmitted, in one embodiment the magnitude of the exceedance is transmitted.

As a result, a controller may be programmed to select for instance sensors 1, 5, 7 and 11 and to measure predetermined exceedances for these sensors. These exceedances are transmitted in the appropriate time slices such that that which is transmitted to listener 30 is a substantially reduced data set having substantially reduced bandwidth over continuously monitored sensor data.

Thus, when multiple sensors are utilized, first and foremost embedding a filter algorithm at the point of performance allows filtering at the, point of performance to select for instance only those sensors deemed appropriate and then to define exceedances for those sensors. Thereafter the exceedances, if they exist for any given sensor, are transmitted in a time slice allocated to that sensor.

The result is that the listener 30 can be rapidly apprised of fault conditions or potential fault conditions in the monitored system without loss of critical data.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

1. In a performance monitoring system involving multiple sensors located at the monitored system, a method for reducing the bandwidth of the transmission of the sensor outputs to a listener, comprising the steps of:
embedding a filter algorithm at the monitored system, the embedded algorithm defining predetermined thresholds for predetermined sensors and for outputting the fact of an exceedance of the associated threshold when such an exceedance occurs; and,
transmitting only the outputted fact of an exceedence to the listener utilizing a time division multiple access system, the outputted fact of an exceedence being transmitted time slot by time slot, whereby the bandwidth of the transmission of the data from the sensors is reduced due to transmitting only exceedances.

2. The method of claim 1, and further including the step of outputting the magnitude of an exceedance and transmitting the magnitude of the exceedance to the listener.

3. The method of claim 1, wherein the embedding of a filter algorithm at the monitored system includes embedding a filter algorithm that specifies which of the multiple sensors are critical and outputs the fact of an exceedance of an associated threshold of a critical sensor only for sensors designated as critical.

4. The method of claim 1, wherein the filter algorithm is embedded at the monitored system utilizing an embedded controller.

5. The method of claim 4, wherein the controller includes a microprocessor for running the filter algorithm.

6. The method of claim 1, wherein time slots are only allocated to critical sensors, whereby the exceedance of a threshold associated with only the critical sensors is transmitted.

7. The method of claim 1, wherein exceedances are monitored only for sensors responsible for critical parameters.

8. The method of claim 7, wherein the critical parameter exceedances are transmitted in predefined time slots assigned to the exceedances deemed to have critical parameters.

9. Apparatus for use in a performance monitoring system that monitors performance of a monitored system, comprising:
multiple sensors for sensing parameters of a system;
a controller including an embedded filter algorithm for defining predetermined thresholds for predetermined sensors and for determining when a predetermined threshold is exceeded, said controller outputting the fact of an exceedance when an exceedance of the predetermined threshold occurs;
a transmitter coupled to said controller for transmitting the fact of an exceedance of the predetermined threshold to a listener, such that transmission to said listener is limited to only the transmitted fact of an exceedance.

10. The apparatus of claim 9, wherein said filter algorithms determine the magnitude of said exceedance and wherein the magnitude of said exceedance is transmitted to said listener.

11. The apparatus of claim 9, wherein said transmitter includes a time division multiple access protocol.

12. The apparatus of claim 11, wherein said time division multiple access protocol defines time slots in which data is to be sent and wherein said transmitter only transmits data in those time slots allocated to critical sensors.

13. The apparatus of claim 9, wherein said filter algorithms determine the magnitude of said exceedance and wherein said transmitter transmits the determined magnitude of said exceedance.

14. The apparatus of claim 9, wherein said controller is embedded at a the point in said monitored system, whereby filtering is performed prior to the transmission from said transmitter.
